(19) United States
(12) Patent Application Publication
(10) Pub. No.: US 2015/0080071 A1
(43) Pub. Date: Mar. 19, 2015

(54) AUGMENTED REALITY FIREARM COMBAT SIMULATOR

(71) Applicant: Nathan Eyal, Altamonte Springs, FL (US)

(72) Inventor: Nathan Eyal, Altamonte Springs, FL (US)

(21) Appl. No.: 14/456,439

(22) Filed: Aug. 11, 2014

Related U.S. Application Data
(60) Provisional application No. 61/864,306, filed on Aug. 9, 2013.

(51) Int. Cl. A63F 13/837; A63F 13/537

(52) U.S. Cl. CPC A63F 13/837; A63F 13/537
USPC 463/2

(57) ABSTRACT

A software application for portable computing devices adapted to simulate weapon combat. A camera is used to display images onto a display screen of the computing device. The image may be modified based on a set of predefined criteria. The predefined criteria may vary based on a virtual weapon being used, environmental conditions, and other factors. Responsive to user input, the current image is captured. The time of the image capture, the geographic location of the user, and identification of the enemy depicted in the image are transmitted along with the image to a centralized server. The time stamp of each transmitted image is analyzed to confirm that the user had not been eliminated prior to capturing the image. Explosives are simulated by using the GPS to determine the location of the explosion and the damage radius.

### BACKGROUND OF THE INVENTION

1. Field of the Invention

This invention relates to software for portable computing devices. More specifically, it relates to a software application for simulating weapon combat.

2. Brief Description of the Related Art

First-person shooting games and virtual combat simulators have been extremely popular for over two decades and constitute a multi-billion dollar industry. Although the popularity of traditional computer and video console games and virtual combat simulators is unquestionable, these technologies do not permit for a physical experience of real weapons combat where participants must physically run, jump, hide, examine the environment, perform demanding activities, and interact socially. These shortcomings of virtual combat simulators and video games are one of the reasons why activities like paintball and laser tag remain key components of combat training and popular social pastimes.

Recent developments in portable computing technology gave rise to a strong demand for more versatile gaming and training options. Portable computing devices provide a platform for combining the aspects of versatility of virtual combat with the physical activity and social interaction of paintball. A few software applications have attempted to achieve this combination, but they have serious flaws.

One example of such portable computing software applications is called CAMGUN. This application provides its users with an opportunity to use their mobile phone as a virtual gun. Although CAMGUN provides a choice of weapons with accompanying sound and visual effects for entertainment purposes, this application is devoid of any gaming functionality.

Another software application in the relevant field is GUNMAN. This application enables users to play against one another and tracks the score based on the number of times each player shoots his opponent. The back camera of a cellphone is used to take a photograph of the target at the time of the shot. A hit is confirmed if the color of the photograph at the center of the crosshairs matches the preselected color of a player's clothing. This confirmation mechanism is very crude and often results in “false hits.” For example, if a player is wearing a green t-shirt and the game is being played on the grass, every time the opponent takes a photograph of the grass, the application identifies a hit despite the player not being present in the photograph. This shortcoming disrupts the gameplay and frustrates the users due to its gross inaccuracy. False misses are also common. This most commonly occurs when light conditions are suboptimal or when the other player is farther away. These flaws become even more problematic if the application is adapted for military training where participants are wearing camouflage to blend in with the surrounding environment.

In view of the art considered as a whole at the time the present invention was made, it was not obvious to those of ordinary skill in the field of this invention how the shortcomings of the prior art could be overcome.

### BRIEF DESCRIPTION OF THE DRAWINGS

For a fuller understanding of the invention, reference should be made to the following detailed description, taken in connection with the accompanying drawings, in which:

FIG. 1 is a exemplary depiction of a screen of a portable computing device showing the graphics user interface of the invention;

FIG. 2 is a flowchart schematically illustrating shot verification method;

FIG. 3 is a flowchart schematically illustrating the method of processing and verifying user eliminations due to geo-based weapons.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The invention is a software application for portable computing devices, such as smart phones and tablets. The invention provides an augmented reality weapon combat simulation.

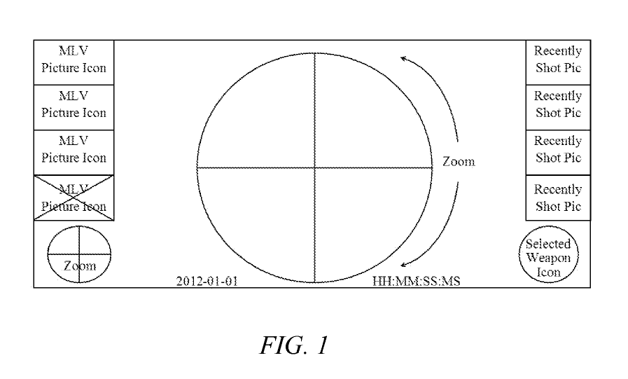

A camera in electrical communication with or integrated into a portable computing device is used to display a live image of the surroundings onto the screen of the device. An example of a screen image is depicted in FIG. 1. The screen may include a scope with crosshairs to facilitate aiming and provide a more realistic and engaging training or gaming experience.

When a user provides an input corresponding to shooting, the camera takes a photograph at the time the input is received. Timestamp and longitudinal and latitudinal coordinates corresponding to each photograph are also recorded. A GPS may be used for obtaining the geographical coordinates of the user at the time the shot was taken.

In weapon combat, exact timing of the shot is critical because a fraction of a second could determine the difference between killing an enemy and being killed by the enemy—a concept that is quite vividly illustrated by duels. Consequentially, the time-stamping feature of the application is integral for accurate determination of which participant was shot first. Relying on an internal clock of each participant's portable computing device is unacceptable because the clocks may be out of sync, and as explained above, even a minor inconsistency could lead to inaccurate results and diminish the effectiveness of training or game play. For this reason, the invention relies on a centralized server to ensure that every participant is playing on the same clock. Alternatively, phones could be synched when players join the game (i.e. when they “bump” phones).

Continuing reference to FIG. 1, a predefined number of the most recent shot photographs is displayed on the right side of the screen. The pictures of members of the opposing team are displayed on the left side of the screen. Upon firing a series of shots, the user examines the shot photographs to visually confirm that a member of an opposing team has been “hit.” Once the user visually identifies the “killed” enemy, he selects the picture corresponding to that individual. Both ribbons on the right and left can be scrolled up and down if needed to reveal more enemies and shot photographs.

Shot photographs are only displayed for a predetermined duration (for example 10 seconds) and then become erased. This feature requires the shooter to review his shot photographs within a confined time period after taking the shot, which allows other participants to become aware of who has been killed within a reasonable amount of time after the kill. This replicates real life combat where team members can see when a colleague or an enemy is shot. Limiting the time duration during which a shot photograph is available also helps to reduce memory usage of the portable computing device since only the most recent shot photographs are saved. Alternatively, the shots could be counted only when sent (i.e. received by the server).

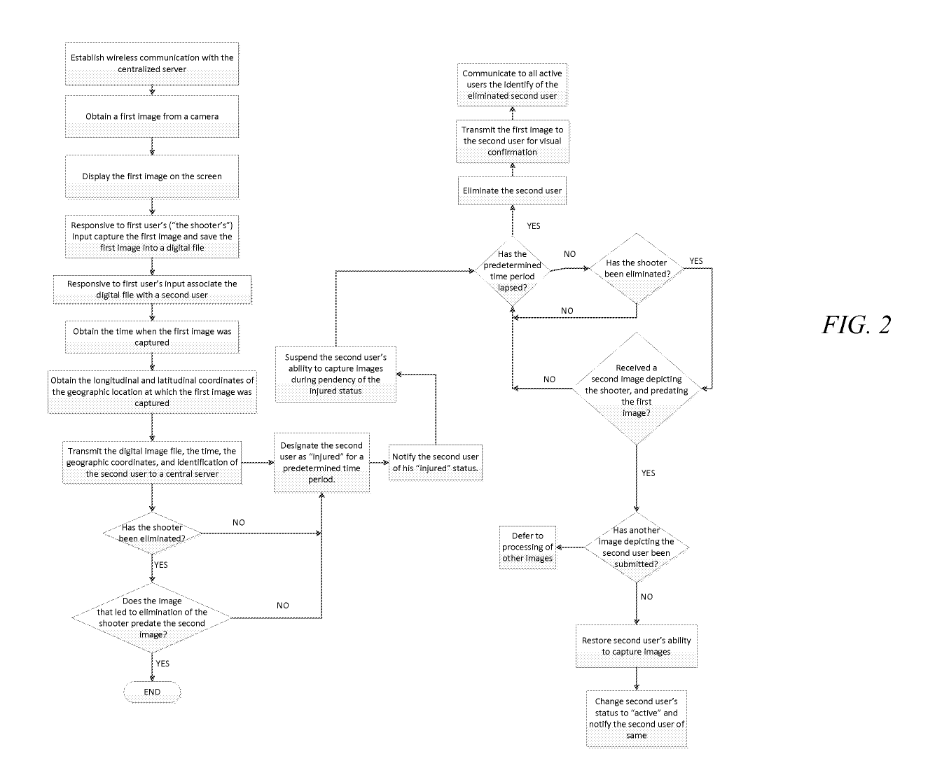

FIG. 2 illustrates kill verification algorithm. When the user simultaneously selects a player and a shot photograph depicting that player, the shot photograph is uploaded to the centralized server. The centralized server compares the time and location stamps of the shots to determine the status of the shooter when shot was taken. There are three possible statuses for each user: active, injured, or eliminated. If the shooter has an “eliminated” status at the time of capturing the shot photograph, the photograph will not result in elimination of the user depicted therein.

For example, participants A, B, and C are involved in a shootout. Participant A takes a shot photograph of Participant B and submits it to the central server. At this point the software application check whether participant A had been eliminated at the time of capturing the shot photograph. If participant had been eliminated, his shot photograph is discarded. Otherwise, if participant A was active at the time of “shooting” participant B, participant B is designated as “injured.”

Participant B is notified of his injured status, during pendency of which, Participant B cannot take any shot photographs, although other participants may continue “shooting” the “injured” participant B. The injury notification may have a number of forms including screen turning a different color, a text notification, a sound alarm, or a combination thereof. The predetermined injury time period allows other participants to upload their shot photographs. If C submits a shot photograph depicting Participant A during this predetermined time period (for example 10 seconds), the application will compare the time stamps on the photographs depicting A and B. If the time stamp on the photograph depicting A predates B, then B will be restored to normal game play because A was “shot” prior to shooting B and, therefore, A's shot will be invalidated. A will be considered “injured” as of the time the shot photograph depicting A is submitted. Otherwise, if no photograph of A being shot prior to B is submitted, B340 s “injured” status will be changed to “eliminated.”

This feature facilitates an uninterrupted and real-life-like training or gaming experience. The time limit established for “injury” period allows the “injured” participants and their teammates to learn of whether the shot was legitimate within a reasonable amount of time. Moreover by limiting the time frame for comparison of received images and corresponding time stamps, the burden on the server is reduced significantly. The injury features also replicates the initial shock of being hit with a bullet which debilitates the injured person at least for a short term.

Another aspect of the invention depicted in FIG. 1 is communication between the software applications and users where the application automatically notifies all users when a participant is shot. One example of this notification scheme involves crossing out the picture of the player from the ribbon of participants displayed on every user's screen.

A participant who has been killed, receives a shot photograph depicting him being shot. This feature allows the killed participant to review the shot photograph to confirm that he has indeed been shot. Should the players disagree about whether the shot was on target, zoomed-in photographs depicting the shot location may be reviewed. This additional level of user verification places a high level of accountability on all participants and discourages cheating. In some embodiments, the combat simulation may be monitored by a human moderator, thus providing an additional layer of confidence and reducing the instances of “false hits,” which plague applications relying on automatic shot identification algorithms.

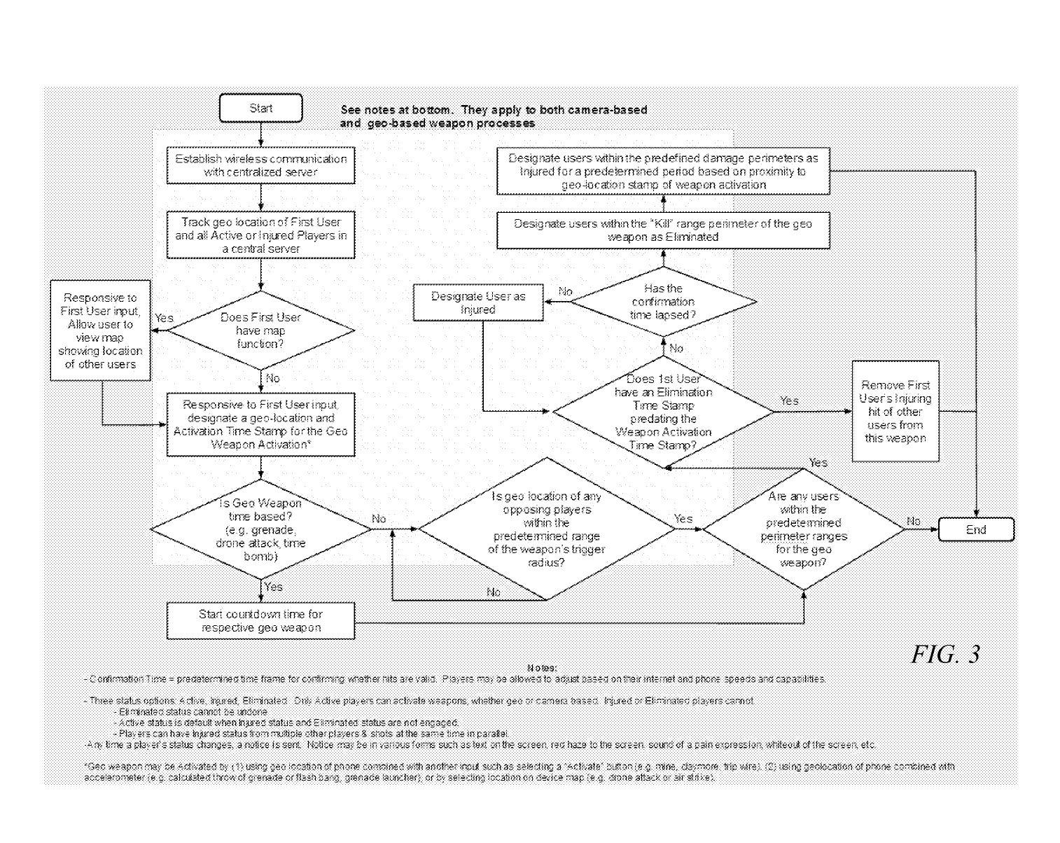

FIG. 3 illustrates another feature of the invention—the geo-based weapons. These weapons may include grenades, trip wires, time bombs, remotely detonating explosives, drone attacks, etc. The geo-based weapons use the latitudinal and longitudinal coordinates to determine the exact geographic location of the placement of the weapon. In case of the weapons that require to be thrown, such as hand grandees, the accelerometer of the handheld computing device may be used to compute the approximate landing point of the “thrown” weapon. Each weapon has a different explosion radius, and all users within that radius at the time of the explosion become eliminated upon verification that the user throwing or placing the weapon had an “active” status at the time the weapon was placed.

Communication and on-line interaction between the users and the application may be accomplished by any means known in the art, including satellite communications, Wi-Fi hot spots, Wi-Fi direct, etc. It is envisioned that it is possible that one or more participants may temporarily lose connectivity. This is accounted for by displaying a message to the user notifying him that his weapon “has been jammed” and advising him to restore the connectivity. Once the user is reconnected to the server, normal operation resumes.

After each game is completed, the results are reported to all users, the moderator, and/or centralized scoring board. This allows the users to track their scores, accumulate points, increase their rank, and participate in long-duration and long-distance competitions with users in any part of the world. Various scoring schemes may be implemented depending on the purpose for which the software application is used (military training vs. casual gaming), mode (free-for-all, team combat, etc.), prior agreements between users, or the rules set by the moderator.

Another aspect of the invention involves audible effects. Preferably, the portable computing device either has integrated audio speakers or external audio speakers in communication with the device. To provide the most realistic training or gaming experience, when shots are being fired, the invention determines the location from which they originate based on the GPS tracker, and provides accurate audio sound that may be used to determine the location of the shooter. This aspect of the invention encourages participants to use stealth whenever possible to avoid being detected by the enemy. Some weapons may involve silencers that reduce or eliminate audible sound when firing.

Another aspect of the invention that advances the state of the art is capability to use various weapons, each having its own unique features mimicking the features of its real-life counterpart. For example, heavier guns are less mobile making them harder to swing around and abruptly change direction of fire. Accordingly, when equipped with a heavy weapon, crosshairs on the screen lag behind the device's major movements. With very fast changes of direction, the crosshairs may even float off the screen, making it impossible to hit an opponent until they float back into the screen since that's where the shot location gets marked. Similarly, some weapons such as handguns are mobile, but less accurate than others. The screen becomes more sensitive to minor movement, making it much harder to stabilize the image on the screen to produce an accurate shot from far away. For these mobile weapons, however, the movement of crosshairs is limited to a smaller area on the screen, which enables the player to abruptly change direction of the firearm for close-distance shots without floating the crosshairs completely off the screen.

Furthermore, some weapons may be automatic giving a capability of making a series of shots in a single shot photograph, thus significantly increasing the chances of hitting the target. Sniper rifles may allow the user to have an advanced scope displayed on the screen and also allow to zoom in, whereas basic weapons may not have a zooming capability. The caliber of the firearm determines the shot zone (i.e. the diameter of the shot on the shot photograph): the larger the caliber, the easier it is to hit the target. For the portable computing devices with a vibration capability, vibration and screen movements may be used to mimic recoil, which also differs based on the weapon type. Other aspects of different weapons may include various magazine sizes and types, accuracy, fire rate, reload time, shot range, night vision, zoom speed and resolution, etc.

The invention also provides for use of grenades and other explosives: a user may place an explosive at a particular geographic location. The location of the explosive is determined through a GPS. Upon detonation of the explosive, participants within a certain radius (which varies on the type of explosive) will be killed or temporarily stunned, which may involve the screen going dark, image blurring or becoming unstable, the device vibrating, emission of loud sound, etc. Different types of explosives may be used: mines which automatically detonate when a participant enters the location in which the mine is set, timed explosives, remotely-detonated explosives, immediately-exploding devices (i.e. grenades), drone attacks, etc. Thrown explosives such as grenades, flash bangs and the like utilize the accelerometer function of the app to calculate the GPS location of the thrown weapon.

In an embodiment, the GPS location is used to determine the local weather conditions including wind speed and direction. To achieve the most realistic recreation of real-life combat, users may be required to account for the wind when shooting. Furthermore, some of the more advanced weapons may be able to notify the user of the presence of the wind, or even automatically correct the aim to compensate for weather conditions.

GPS may also be used to calculate the distance between the shooter and his target, and require the shooter to correct the aim based on the distance or shrink the distance to get a qualified hit. For instance, when a shot is taken from a short-range firearm such as a shotgun, the distance of the target is calculated through GPS. If the players are within close range, the shot eliminates the target. In moderate range, the target only gets injured for a short period (e.g. graying out the screen). If the player and target are completely outside the range of the weapon, the shot is voided for being out of range. These aspects of the invention enable participants to experience augmented reality weapon combat in a very realistic way. The level of difficulty and realism of the application may be adjusted based on the purpose for which the application is being used and the level of sophistication of the participants. For example, it may be desirable to mimic the exact real-life conditions if the application is being used for military training, while a simply easy-to-play version may be better suited for children using the software application for casual gameplay.

Another aspect of the application is caliber of the equipped weapon. All projectiles are not equal—higher caliber bullets have a bigger impact than smaller caliber weapons. The size of the projectile is simulated proportionately by the size of the hit marks on the killcam.

### EXAMPLE

The following is an example of a software application according to the invention. The example provides an illustration of specific rules and features that could be implemented. The example should be interpreted as illustrative of the invention and not in a limiting sense.

General Game Play Concepts
1. Primary weapon
   a. Reload after every shot
   b. Iron site
   c. Low accuracy (site floats with minor phone movements)
   d. Phone volume automatically goes to max,
      i. Silencer can be purchased, but have option for “public play” to change sound of bullet to laser or similar.

2. Shooting process:
a. Whenever a shot is fired (i.e. picture taken), that picture will be shown in small version on the right side of the screen, so that user can see if target was hit.
   i. Each picture gets a timestamp and a gps stamp
   ii. Most recent five shots are displayed on the right side of the screen, and player can scroll through more old shots.
   iii. Pictures MUST be reviewed and sent within 10 seconds to avoid people shooting several enemies without the enemy team members knowing it.
      1. This replicates real life better (i.e. team members would see if their colleague got shot). Also helps reduce memory draw of the phone if it only saves recent and sent pics.
b. When player sees a hit, that player presses the picture of the hit while also pressing the picture of the respective victim on the left side of the screen.
   i. Both must be pressed at the same time to send the kill.
   ii. If more than five players are in the game, players can scroll the pictures of their enemies on the left. Their own team members need not show up there.
c. Message sent to server and chosen player with time stamp of shot and shot player receives copy of same (through server or Wi-Fi direct).
   i. Picture being sent gets split into two:
      1. First half: full pic with pin icons pointing to all shots in picture—black and white arrows on all four sides of the shot.
      2. Second half: close-up of all shots to distinguish whether hit was really made—all shot marks will use a color that contrasts the background color of the shot area.
      3. Exception: when explosive attack like grenade or aerial attack, just provide picture of radar view with circles indicating the damaged zones and pointing out where the hit victim was at.
d. The victim is out of the game, but if any player sends a picture of the shooter getting shot first (as evaluated by the time stamp), subsequent kills of the shooter are reversed (i.e. the original victim gets a message that they were healed).
e. Once a player is eliminated, the respective icon on all participants' devices becomes faded, and a red “X” is printed over it.
f. If a player loses connectivity, the player gets a message that says jammed firearm (lost communication)
3. Post-Game reporting
   a. Post-game scoreboard, shows up on everyone's phones
      i. 0 kills you still get 25 xp for playing
      ii. 100 xp for each kill you get
      iii. 150 xp if you don't die
   b. Stats are uploaded to website and server as soon as internet connection or reception is available.

| America (550) | Points | Kills | Deaths |
|---|---|---|---|
| NathanTheKilla | 450 | 3 | 0 |
| GunSlinger | 100 | 1 | 1 |
| Born2Kill | 100 | 1 | 1 |
| EvilMonkey | 25 | 0 | 1 |
| RedEeagle | 25 | 0 | 1 |

| Russia (450) | Points | Kills | Deaths |
|---|---|---|---|
| EvilBob | 200 | 2 | 1 |
| MadDog | 100 | 1 | 1 |
| CuteTeddyBear | 100 | 1 | 1 |
| PurpleUnicorn | 25 | 0 | 1 |
| GhostShooter | 25 | 0 | 1 |

4. Ranking
   a. Player gets points from every game
   b. It takes points to get ranked up to the next level, and to buy new guns
      i. Players can't download the app and then buy all of the best guns, players must have at least 50 points to buy most of the guns, and other minimum point levels will be assigned for each new firearm & upgrade.
   c. Sample ranking scheme is illustrated in FIG. 2.
5. Point System and Pay Method:
   a. “Platinum Coins” are purchased
   b. Upgrades require a combination of both coins and experience points to buy some guns, players can't just get the game and buy all the best stuff.
6. Upgrades:
   a. Single shot—reload every time by shaking the phone
   b. Semi Auto
   c. Full Auto
   d. Scope zoom
   e. Extended mag
   f. Mines
   g. Claymore
   h. EMP (electro mag pulse)
   i. Rear-facing cam
   j. Air Strike
   k. Predator Strike
   l. Radar/UAV
   m. Silencer
   n. Grenades
   o. Flash bangs
   p. Style and functionality variations of all upgrades (e.g. 1942 AK47 in gold)
7. Effectiveness categories for firearms include: (All categories are on an effectiveness scale from 1-10)
   a. Zoom in speed & resolution: higher end scope uses full mechanical capability of the phone along with highest resolution picture.
   b. Mobility—how “heavy” the gun is affects how fast it can move.
      i. To mimic gun mobility, the site on heavy guns lags when the phone moves.
      ii. Fast movement on a heavy gun can force the site to lag completely off of the screen.
      iii. Slight phone movements even while trying to hold steady make the site move. Heavier guns more affected by this than lighter guns.
   c. Recoil—site jumps based on the caliber and recoil features of the gun.
   d. Fire rate
      i. in basic auto firearms, one pic per shot
      ii. in high-speed firearms, multiple shots per picture
         1. Spread and direction of the shots within the picture determined by phone's movement accelerometer and directional sensors. E.g. fast movement to the right puts three dots far apart from right to left across the pic. Slow movement, puts the dots closer together.
         2. Recoil would be accounted for within the algorithm printing the shots on the pic.
   e. Magazine size & type
   f. Sight capability—red dot, acog, reflex, iron site, sniper scope
   g. Reload time
   h. Range—The size of the shot on the screen
8. Categories for grenades, and other explosives (land and air)
   a. Weight
   b. Explosive potential (i.e. size of affected area rings in kill cam)
   c. Effect (eyes, sound, and/or damage)
9. Kevlar, shield & other defense mechanisms
10. Flag, Reload, disarm bomb features:
   a. Use GPS to enable flag, bomb, and ammo location based activation.
11. Player customizable rules:
   a. Start game timer
   b. In game time limit
   c. Number of hits per kill
      i. When injured, player's screen gets a red tint and the scope becomes much more sensitive to the phone's movement causing it to sway across the screen.
12. Game Modes
   a. Free-for-all
   b. Team Battle
   c. Assassination
   d. WWIII—numerous teams and long-term play
   e. Capture the Flag
   f. Domination
   g. Search & Destroy
   h. Kill Confirm—dog tag pickup
   i. Sabotage
   j. Headquarters
13. In the main play screen, identify most likely victims by gps coordinates of other players and which direction the shooter is shooting. Push most likely victim's pictures to the top of the list on the left.
14. Communication app for connecting old phones & ipods to R/C vehicles (air and land) to be used as robotic attack vehicles.
15. Hardware: specialized hardware may be developed to integrate with the portable computing device. For example, a gun-like controller may be adapted to communicate with a portable computing device running the application.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. One or more non-transitory tangible computer-readable media having computer-executable instructions for performing a method by running a software program on a computing device, the computing device operating under an operating system, the method including issuing instructions from the software program comprising:
establishing wireless communication with a server;
receiving a first image from a camera in communication with the computing device;
displaying the first image on a display screen of the computing device;
responsive to a first user input capturing the first image and saving the first image into a digital file;
responsive to a first user input identifying a second user depicted in the first image;
identifying a time when the first image was captured;
identifying longitudinal and latitudinal coordinates of a geographic location where the image was captured;
disabling the second user's ability to capture images of a predetermined period of time subsequent to receipt of the first image;
receiving subsequent images during the predetermined period of time;
comparing subsequent images with the first image to determine whether a second image exists, the second image identifying the first user and predating the first image; and
responsive to identifying the second image, restoring the second user's ability to capture images.

2. The media of claim 1, further comprising the instructions to perform the steps of:
upon receiving the image from the camera, modifying the image based on a set of predefined criteria.

3. The media of claim 2, wherein the set of predefined criteria is associated with a virtual weapon being active.

4. The media of claim 3, wherein the predefined criteria is selected from the group consisting of resolution, magnification, lag, sharpness, overlaying images, and a color scheme.

5. The media of claim 2, wherein the set of predefined criteria is associated with a distance between the first user and a target.

6. The media of claim 5, wherein the distance between the user and the target is calculated based on the longitudinal and latitudinal coordinates.

7. The media of claim 2, wherein the set of predefined criteria is based on a current wind speed and direction at the geographic location identified by the longitudinal and latitudinal coordinates.
